(19) United States
(12) Patent Application Publication
(10) Pub. No.: US 2026/0361766 A1
(43) Pub. Date: Nov. 12, 2026

(54) SYSTEMS AND METHODS OF AGENT-BASED NETWORK SECURITY USING ADAPTIVE QUALITY OF SERVICE (QOS)

(71) Applicant: Salesforce, Inc., San Francisco, CA (US)

(72) Inventors: Jose LEJIN P J, Bengaluru (IN); Ratheesh Krishna VADHYAR, Bengaluru (IN); Swaroop JAYANTHI, Hyderabad (IN)

(21) Appl. No.: 19/199,574

(22) Filed: May 6, 2025

(51) Int. Cl. H04L 9/40

(52) U.S. Cl. CPC H04L 63/20; H04L 63/1416; H04L 63/1441

(57) ABSTRACT

Systems and methods are provided for receiving end user data for a plurality of network activities at a server. At least one network security policy may be dynamically generated or updated at an agent of an artificial intelligence (AI) system. The agent of the AI system may be used to determine anomalous behavior in the received end user data based on the dynamically generated or updated at least one network security policy. The agent of the AI system may correlate one or more network parameters with determined anomalous behavior. The server may generate adaptive Quality of Service (QoS) policies based on the one or more network parameters. The server may perform isolating, mitigating, and/or blocking an end user that performed the determined anomalous behavior by dynamically using the generated adaptive QoS policies.

### BACKGROUND

Traditional protection mechanisms are not able to provide defense against network attacks generated by new artificial intelligence (AI) systems, because the attackers can target slow forms of attacks over a period of time, initiated in a completely distributed fashion. That is, it can be difficult to detect and stop such an attack using traditional protection mechanisms, such as rate limiting.

Some current mechanisms for differentiating between humans and bots are likely to see a reduction in efficacy in coming years because of the continuously evolving capabilities of AI based programs in close-to-human capabilities. This may include areas like image scanning, pattern recognition, tagging and categorization, speech recognition and mimicking of mouse movements, and the like, which are typically employed in bot detection mechanisms.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-5 show an example method of addressing artificial intelligence (AI) based network and/or website attacks according to implementations of the disclosed subject matter.

FIG. 6 shows an example system to perform the operations of FIGS. 1-5 according to implementations of the disclosed subject matter.

FIG. 7 shows an example computer system that may include the system of FIG. 6 and may perform the example methods of FIGS. 1-5 according to implementations of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter provide systems and methods for defense against attackers employing artificial intelligence (AI) based attacks. The growing power and features of AI technologies, along with their continuously evolving capabilities, can be utilized by attackers in creating AI based programs and/or bots that simulate or mimic real human behavior. Such programs and/or bots can target users and/or organizations to create sophisticated forms of security attacks that can be undetected by traditional attack detection mechanisms.

For example, an AI based program can target an e-commerce website and continuously monopolize and/or drain its resources by creating fake user accounts, traversing through various product listings, adding AI generated review comments for products, adding large number of products to shopping cart or wish list without ever purchasing any of them, and the like. These kinds of attacks can result in the organizations allocating unnecessary computation resources, which may also add to the operational cost of operating the e-commerce website.

Traditional protection mechanisms like rate limiting are unlikely to be able to effectively address AI based attacks, as the attackers may use slow forms of attacks over a period of time, which may be initiated in a distributed fashion. CAPTCHA™ (Completely Automated Public Turing Test to tell Computers and Humans Apart) based mechanisms for differentiating between human and bots may have reduce efficacy because of the continuously-evolving capabilities of AI based programs in close-to-human capabilities in areas such as image scanning, pattern recognition, tagging and categorization, speech recognition, mimicking of mouse movements, and the like, which are typically employed in bot detection mechanisms.

Implementations of the disclosed subject matter may provide systems and methods for generating organization-specific AI-based policies to address anomalous network behavior. For example, each organization may generate and/or define policies on categorizing and/or grouping end customers based on the user activities. In some implementations, one or more predefined templates may be used to define one or more policies. For example, an organization may use a predefined template to perform one or more categorization operations.

Implementations of the disclosed subject matter may include a database of end user activities, events, and/or behavioral logs. For example, each organization (i.e., “org”) may log the org-specific activities and/or events of each customer in a database, such as: products, items, and/or information browsed; products and/or information resources purchased; products canceled and/or returned; products and/or items reviewed; products and/or items added or deleted from a shopping cart; products and/or items added or deleted to a wish list, purchase status of product or item, and the like. These are merely examples of events and/or activities, and other suitable events and/or activities may be added to the database. The inventive concepts described throughout may be used by different organizations, and is not limited to electronic commerce. For example, the inventive concepts may be used for event management, education, government, organizations, and/or other businesses.

Implementations of the disclosed subject matter may provide an AI-based behavioral analysis agent, which may include a behavioral analysis module and a source correlation module. The AI-based behavioral analysis agent may continuously and/or periodically analyze the contents of the end user activity database. The AI-based behavioral analysis agent may learn from the logs in the database, and may detect anomalous behavior.

The behavioral analysis module, which may be a sub-module of the AI-based behavioral analysis agent, may analyze the end user behavioral patterns and may validate them against one or more AI policies defined by the customer organization and/or the predefined templates. The format of the log messages may vary between organizations. In some implementations, the format of the log messages may vary within the same organization. The format of the log messages may change over a period of time (e.g., due to software updates and the like). However, the behavioral analysis module may be configured to apply natural language processing techniques to categorize them and compare them against AI-policies. In some implementations, AI-policy templates may be used, which may be written in an organization-agnostic way, and the behavioral analysis module may perform the policy matching using AI based techniques.

The source correlation module, which may be a sub-module of the AI-based behavioral analysis agent, may determine dynamic correlations between the source signature of requests at different network layers (e.g., internet protocol (IP) address, browser unique identifier (UID), username for an account, or the like). The source correlation module may analyze external threat feeds to get additional information. The source correlation module may create a linkage between the anomalous behavior of a set of user IDs with browser UIDs and originating IP addresses.

Implementations of the disclosed subject matter may include a policy generation module. Based on AI-based deduction using the AI-based behavioral analysis agent, adaptive Quality of Service (QoS) parameters and/or policies may be generated which may be applied to the network devices and/or network clouds as applicable. For example, end users determined to be suspicious in view of the policies may be assigned to a lower QoS level. In another example, Distributed Denial-of-Service (DDoS) policies may be applied to block offending end users. The policies may be continuously adapted based on ongoing monitoring and/or feedback from the behavioral analysis conducted by the AI-based behavioral analysis agent.

Implementations of the disclosed subject matter differ from traditional network attack detection and mitigation arrangements that use rule-based detection mechanisms by using an AI agent to detect malicious users targeting computer and/or cloud networks, hardware, applications, and/or websites. Unlike traditional static detection methods, implementations of the disclosed subject matter use dynamic AI-based policies for behavioral pattern analysis. The disclosed subject matter correlates these patterns with network parameters to identify and isolate offending sources of attack.

Implementations of the disclosed subject matter integrates a real-time AI-driven feedback loop, ensuring continuous policy adaptation based on evolving threat landscapes.

Implementations of the disclosed subject matter provide a multi-layered defense mechanism, considering both behavioral analytics and network signature correlations for comprehensive protection.

Unlike existing security solutions that primarily focus on predefined attack signatures, the AI-based systems and method of the disclosed subject matter may proactively learn and adapt to new attack vectors in real-time, which may improve threat mitigation effectiveness. The AI-based systems and method of the disclosed subject matter may allow organizations of different types to define their own policies to address attacks, and to revise and/or update these policies to adapt to addressing new attack vectors.

Implementations of the disclosed subject matter may be customized for individual organizations, which may allow for organization-specific policies and/or tuning. This may provide a tailored and/or scalable approach to security.

That is, implementations of the disclosed subject matter may improve upon current static detection methods by using AI-based system to dynamically generate and/or enforce policies for behavioral pattern analysis and may correlate these patterns with network parameters to identify and isolate offending sources of attack. Implementations of the disclosed subject matter may use AI to learn and/or adapt to new attack vectors in real-time, improving threat mitigation effectiveness. Implementations of the disclosed subject matter may allow for organization-specific policies and tuning, which may provide a tailored and/or scalable approach to security over existing systems.

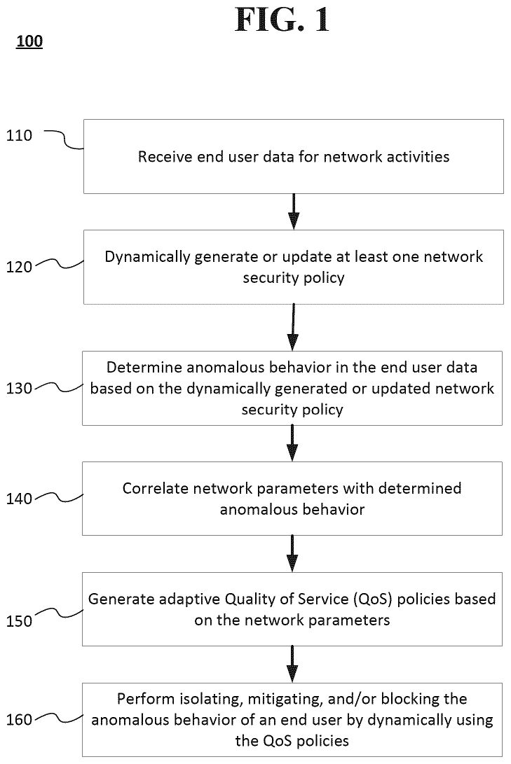

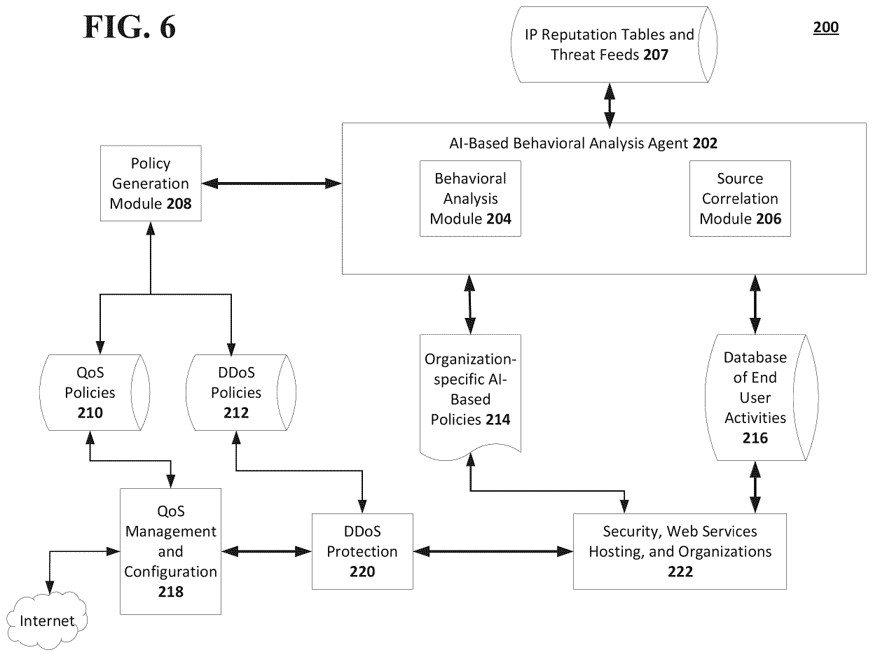

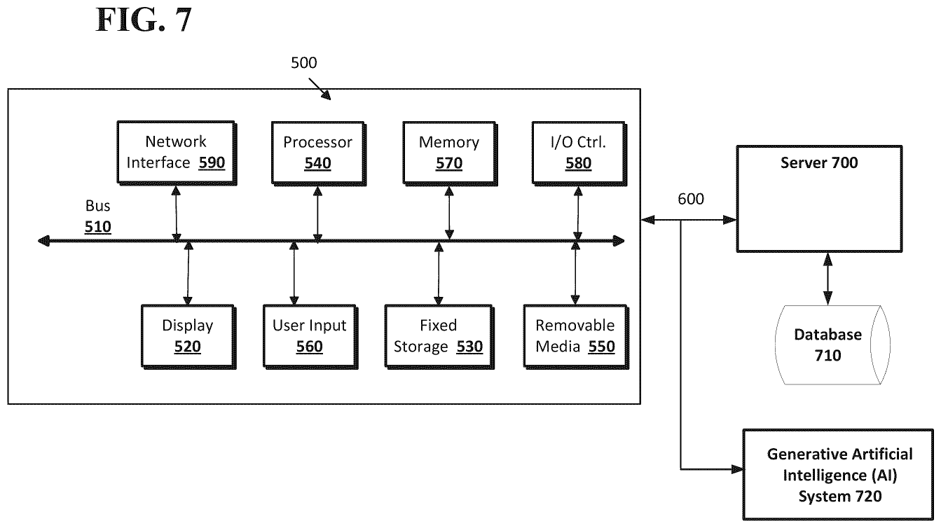

FIGS. 1-5 show an example method 100 of addressing artificial intelligence (AI) based network and/or website attacks according to implementations of the disclosed subject matter. As shown in FIG. 1, a server (e.g., server 700 shown in FIG. 7, an AI-based behavioral analysis agent 202 shown in FIG. 6 instantiated by server 700 from generative AI system 720 shown in FIG. 7, or the like) may receive end user data for a plurality of network activities at operation 110. The end user data may be stored in database of end user activities 216 shown in FIG. 6. Such activity may be from security, web services hosting, and organizations 222 shown in FIG. 6, which may host the web site for one or more organizations.

An agent of an AI system communicatively coupled to the server may dynamically generate or update at least one network security policy at operation 120. The AI system may be generative AI system 720 shown in FIG. 7, and the agent may be AI-based behavioral analysis agent 202 shown in FIG. 6 and described below. The generated and/or updated policy may be organization-specific AI-based policies 214 shown in FIG. 6 and described below.

In some implementations, the dynamically generating or updating the at least one network security policy may be based on grouping end users by using the plurality of network activities. The grouping end users may be based on one or more templates. For example, organization-specific AI-based policies 214 may include one or more template policies, which may be generalized for one or more organizations (i.e., organization-agnostic). Users of an organization may be grouped by one of the templates, where the templates may have one or more policies to be applied to the activities of the users that are grouped with the template.

The agent of the AI system may determine anomalous behavior in the received end user data based on the dynamically generated or updated at least one network security policy at operation 130. That is, the AI-based behavioral analysis agent 202 may compare one or more network security policies 214 with the database of end user activities 216 to determine anomalous behavior. Examples of anomalous behavior may be a user creating fake user accounts, traversing through various product listings, adding AI-generated review comments for products, adding large number of products to shopping cart or wish list without ever purchasing any of them, and the like. In some implementations, the anomalous behavior may be determined by the agent of the AI system to be a network attack, and the AI agent may perform attack mitigation for the determined network attack. In some implementations, the AI agent may engage in continuous learning for network attack detection and/or network attack mitigation based on at least a portion of the end user data.

At operation 140, the agent of the AI system may correlate one or more network parameters with the determined anomalous behavior. For example, the network parameters may be Quality of Service (QoS) parameters which may be used to measure network performance, such as latency (i.e., the time it takes for data to travel from one point to another), bandwidth (i.e., the maximum amount of data that can be transmitted over a network link in a given amount of time), packet loss (e.g., the percentage of data packets that are lost during transmission due to network congestion or other issues), throughput (i.e., he actual rate at which data is transmitted over a network link, which may be less than the bandwidth), and the like. These QoS parameters may help ensure that network resources are efficiently allocated and that different types of traffic receive the appropriate level of service.

The server may generate adaptive QoS policies based on the one or more network parameters at operation 150. For example, a policy generation module 208 of the server may generate the QoS policies, which may be stored as QoS policies 210 shown in FIG. 6.

At operation 160, the server may isolate, mitigate, and/or block an end user that performed the determined anomalous behavior by dynamically using the generated adaptive QoS policies. That is, the generated adaptive QoS policies may be applied by the server to the user that engaged in the anomalous behavior to minimize and/or prevent future attacks to the network, website, and/or application.

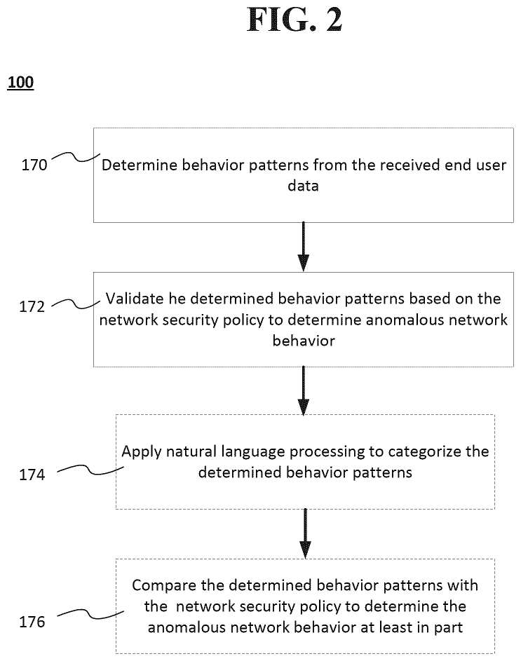

Additional operations of method 100 that may be optional are shown in FIG. 2. At operation 170, the agent of the AI system may determine behavior patterns from the received end user data. The agent may validate the determined behavior patterns based on the at least one network security policy to determine anomalous network behavior. In some implementations, the validating operation 172 may include optional operations 174 and 176, as shown in FIG. 2. At operation 174, the agent may apply natural language processing (e.g., using the generative AI system 720 shown in FIG. 7) to categorize the determined behavior patterns. At operation 176, the agent may compare the determined behavior patterns with the at least one network security policy to determine the anomalous network behavior at least in part.

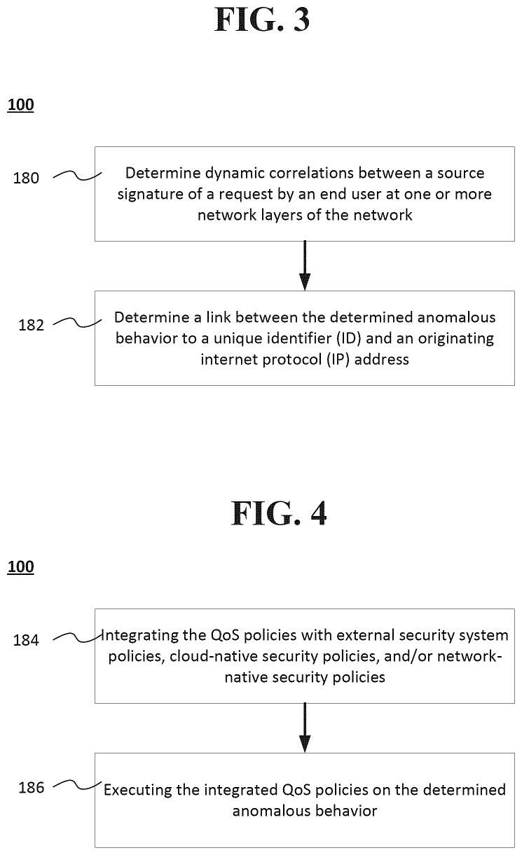

FIG. 3 shows additional operations of method 100 that may be optional according to implementations of the disclosed subject matter. At operation 180, the agent of the AI system may be used to determine dynamic correlations between a source signature of a request by an end user at one or more network layers of the network. For example, the request may be made by computer 500 shown in FIG. 7 for one or more operations and/or functions performed by an application and/or website provided by server 700. At operation 182, the agent may determine a link between the determined anomalous behavior to a unique identifier (ID) and an originating internet protocol (IP) address. That is, the agent may determine an identifier for a specific user at a particular IP address that engaged in the determined anomalous behavior. The system 200 may be used to prevent reduce and/or prevent future anomalous behavior from the specific user at the originating IP address.

FIG. 4 shows additional operations of method 100 that may be optional according to implementations of the disclosed subject matter. At operation 184, the server may integrate the QoS policies (e.g., QoS policies 210 shown in FIG. 6) with external security system policies, cloud-native security policies, and/or network-native security policies. For example, QoS management and configuration 218 shown in FIG. 6 may integrate the QoS policies with external security system policies (e.g., which may be defined in security, web services hosting, and organizations 222). The external security system policies may include, for example: a network security policy, which may provide rules for accessing and using an organization's network infrastructure, and which may include guidelines for network architecture, firewalls, intrusion detection and prevention systems, and wireless network security; an acceptable use policy, which may defines what is and is not permitted when using an organization's technology resources, including computers, networks, and email; access control policy, which may determine who has access to specific systems, data, and applications, and the like. By integrating the QoS policies 210 with external security system policies, cloud-native security policies, and/or network-native security policies, the method 100 may be able to mitigate traditional and/or AI-based attacks on networks, applications, and/or websites.

The method 100 may include additional operations, such as storing the end user data in a database that is communicatively coupled to the server. For example, the database 710 that is communicatively coupled to the server 700 as shown in FIG. 7 may store the end user data. In some implementations, the database 710 may be database 216 shown in FIG. 6, which may store the end user activities (i.e., end user data). The end user data may be data related to actions performed by the user in connection with an application and/or website provided by the server 700.

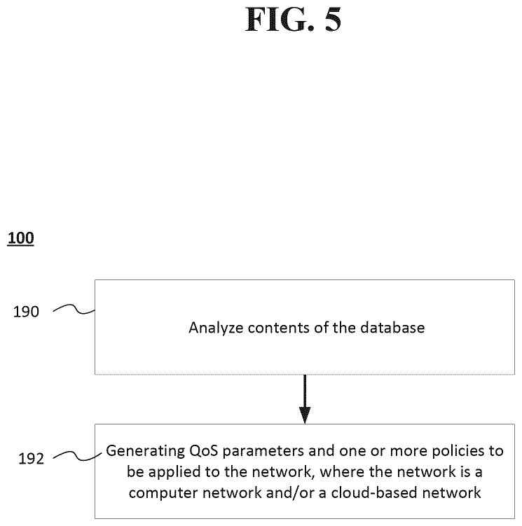

FIG. 5 may show additional operations of method 100 that may be optional. At operation 190, the agent may analyze the contents of the database (e.g., database 216, database 710, or the like). The database contents may include, for example, end user data. At operation 192, the agent may generate QoS parameters and one or more policies to be applied to the network. The network may be a computer network and/or a cloud-based network. That is, the agent may determine if there is anomalous behavior in the contents of the database, and may generate one or more QoS parameters to be applied to prevent the same and/or similar types of anomalous behavior.

FIG. 6 shows an example system 200 to perform the operations of FIGS. 1-5 according to implementations of the disclosed subject matter. The system 200 may be implemented by the server 700, database 710, and/or the generative AI system 720 shown in FIG. 7 and described below.

AI-based behavioral analysis agent 202 of system 200 may be specific to an application and/or website. For example, an application and/or website may be executed by server 700 shown in FIG. 7. The application and/or website of server 700 may instantiate AI-based behavioral analysis agent 202 from generative AI system 700 shown in FIG. 7.

The AI-based behavioral analysis agent 202 may continuously and/or periodically analyze the contents of database of end user activities 216. In some implementations, the database of end user activities 216 may be at least a part of database 710 shown in FIG. 7 and described below. The AI-based behavioral analysis agent 202 may learn (e.g., using machine learning techniques) from the logs in the database of end user activities 216, and may detect anomalous behavior (e.g., as described above in connection with FIGS. 1-5). The database of end user activities 216 may store the user activities from one or more organizations (that have an application and/or website) of security, web services hosting, and organizations 222.

AI-based behavioral analysis agent 202 may include a behavioral analysis module 204 which may analyze the end user behavioral patterns and may validate them against one or more AI policies defined in organization-specific AI-based policies 214. The behavioral patterns may be determined by the behavioral analysis module 204 from the database of user activities 216. The behavioral analysis module 204 may apply the organization-specific AI-based policies 214 to the patterns determined from the database of user activities 216. These AI policies (e.g., organization-specific AI-based policies 214) may be specific for an organization, and/or may include predefined templates for one or more policies.

The format of the log messages in the database of end user activities 216 may vary between organizations. In some implementations, the format of the log messages may vary within the same organization. The format of the log messages may change over a period of time (e.g., due to software updates and the like). However, the behavioral analysis module 204 may be configured to apply natural language processing techniques to categorize the log messages and compare them against organization-specific AI-based policies 214. In some implementations, predetermined AI-policy templates that are written in an organization-agnostic way may be used, and the behavioral analysis module 204 may be able to perform the policy matching using AI based techniques.

The AI-based behavioral analysis agent 202 may include a source correlation module 206, which may determine dynamic correlations between the source signature of requests at different network layers (e.g., internet protocol (IP) address, browser unique identifier (UID), username for an account, or the like). The source correlation module 206 may analyze external threat feeds from IP Reputations Tables and Threat Feeds 207 to get additional information. IP reputations tables and threat feeds 207 may include information regarding one or more internet protocol (IP) addresses, and whether actors having a particular IP address pose threats. The IP reputations tables and threat feeds 207 may provide threat feeds, which may be periodically and/or continuously provided to the source correlation module 206. The source correlation module 206 may create a linkage between the anomalous behavior of a set of user IDs with browser UIDs and originating IP addresses.

System 200 may include policy generation module 208. Based on AI-based deduction using the AI-based behavioral analysis agent 202, adaptive Quality of Service (QoS) parameters and/or policies may be generated by the policy generation module 208 which may be applied to the network devices and/or network clouds as applicable (e.g., one or more devices communicatively coupled to communications network 600 shown in FIG. 7). For example, end users determined to be suspicious in view of one or more policies (e.g., QoS Policies 210 and/or Distributed Denial-of-Service (DDoS) policies 212) may be assigned to a lower QoS level using QoS management and configuration 218. In another example, DDoS policies 212 may be applied by DDoS protection 220 to block offending end users (e.g., users that initiate DdoS attacks on the application and/or website hosted by web services hosting 222 and/or that is provided by server 700 shown in FIG. 7. The policies (e.g., QoS Policies 210 and/or DDoS policies 212) may be continuously adapted based on ongoing monitoring and/or feedback from the behavioral analysis conducted by the AI-based behavioral analysis agent 202.

In some implementations, the QoS Policies 210 and/or the QoS management and configuration 218 may be for layer 3 (L3), which may be the network layer. The DDoS Policies 212 and/or the DDoS protection 220 may be for layer 7 (L7), which may be the application layer.

Implementations of the disclosed subject matter may be implemented in and used with a variety of component and network architectures. FIG. 7 shows an example computer 500 may allow a user to interact with the server 700 (or one or more other servers communicatively coupled to communications network 600), database 710, and/or generative artificial intelligence (AI) system 720 that is suitable for performing the operations detailed in FIGS. 1-5, and which may include the components of system 200 shown in FIG. 6. Although one server 700 is shown in FIG. 7, there may be a plurality of servers communicatively coupled to communications network 600 to perform the operations detailed in FIGS. 1-5. The computer 500 may be a single computer in a network of multiple computers.

In some implementations, the computer 500 may communicate with and may be used to receive one or more responses generated by server 700, database 710, and/or generative AI system 720. The server 700 and/or generative AI system 720 may be one or more hardware servers, virtual machines, cloud servers, databases, clusters, application servers, neural network systems, processors, devices, computers, or the like. The database 710 may use any suitable combination of any suitable volatile and non-volatile physical storage mediums, including, for example, hard disk drives, solid state drives, optical media, flash memory, tape drives, registers, and random access memory, or the like, or any combination thereof. The database 710 may store data, such as tenant data for an application, user data (i.e., end user activity data), user profile data, metadata, application data, and the like.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random-access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 7 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving”, “generating”, “updating”, “determining”, “correlating”, “performing”, “validating”, “applying”, “comparing”, “integrating”, “executing”, “storing”, “analyzing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general-purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

In various implementations, the models and/or modules described herein may be classification, predictive, generative, conversational, or another form of artificial intelligence (AI) technology, such as AI model(s), agents, large language models (LLMs), etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
receiving, at a server, end user data for a plurality of network activities;
dynamically generating or updating, at an agent of an artificial intelligence (AI) system communicatively coupled to the server, at least one network security policy;
determining, using the agent of the AI system, anomalous behavior in the received end user data based on the dynamically generated or updated at least one network security policy;
correlating, using the agent of the AI system, one or more network parameters with the determined anomalous behavior;
generating, at the server, adaptive Quality of Service (QoS) policies based on the one or more network parameters; and
performing, at the server, at least one selected from a group consisting of: isolating, mitigating, and blocking an end user that performed the determined anomalous behavior by dynamically using the generated adaptive QoS policies.

2. The method of claim 1, wherein the determining the anomalous behavior comprises determining a network attack using the agent of the AI system that is communicatively coupled to the server.

3. The method of claim 2, further comprising:
performing, using the agent of the AI system, attack mitigation for the determined network attack.

4. The method of claim 2, further comprising:
performing, using the agent of the AI system, continuous learning for network attack detection and network attack mitigation based on at least a portion of the end user data.

5. The method of claim 1, further comprising:
determining, using the agent of the AI system, behavior patterns from the received end user data; and
validating, using the agent of the AI system, the determined behavior patterns based on the at least one network security policy to determine anomalous network behavior.

6. The method of claim 5, wherein the validating comprises:
applying, using the agent of the AI system, natural language processing to categorize the determined behavior patterns; and
comparing, using the agent of the AI system, the determined behavior patterns with the at least one network security policy to determine the anomalous network behavior at least in part.

7. The method of claim 1, further comprising:
determining, using the agent of the AI system, dynamic correlations between a source signature of a request by an end user at one or more network layers of the network; and
determining, using the agent of the AI system, a link between the determined anomalous behavior to a unique identifier (ID) and an originating internet protocol (IP) address.

8. The method of claim 1, further comprising:
integrating, at the server, the QoS policies with at least one selected from a group consisting of: external security system policies, cloud-native security policies, and network-native security policies; and
executing, at the server, the integrated QoS policies on the determined anomalous behavior.

9. The method of claim 1, wherein the dynamically generating or updating the at least one network security policy is based on grouping end users by using the plurality of network activities.

10. The method of claim 9, wherein the grouping end users is based on one or more templates.

11. The method of claim 1, further comprising:
storing, in a database communicatively coupled to the server, the end user data.

12. The method of claim 11, further comprising:
analyzing, at the agent of the AI system, contents of the database; and
generating, using the agent of the AI system, QoS parameters and one or more policies to be applied to the network, wherein the network is at least one selected from a group consisting of: a computer network, and a cloud-based network.

13. A system comprising:
a server including at least one hardware processor and communicatively coupled to an artificial intelligence (AI) system,
wherein the system is configured to:
receive end user data for a plurality of network activities;
dynamically generating or updating, at least one network security policy using an agent of the AI system;
determine anomalous behavior in the received end user data based on the dynamically generated or updated at least one network security policy using the agent of the AI system;
correlate one or more network parameters with the determined anomalous behavior using the agent of the AI system;
generate adaptive Quality of Service (QoS) policies at the server based on the one or more network parameters; and
perform at least one selected from a group consisting of: isolating, mitigating, and blocking an end user that performed the determined anomalous behavior by dynamically using the generated adaptive QoS policies.

14. The system of claim 13, wherein using the agent of the AI system determines the anomalous behavior by determining a network attack using the agent of the AI system that is communicatively coupled to the server.

15. The system of claim 14, wherein the agent of the AI system is used to perform attack mitigation for the determined network attack.

16. The system of claim 14, wherein the agent of the AI system is used to perform continuous learning for network attack detection and network attack mitigation based on at least a portion of the end user data.

17. The system of claim 13, wherein the agent of the AI system is used to determine behavior patterns from the received end user data, and validate the determined behavior patterns based on the at least one network security policy to determine anomalous network behavior.

18. The system of claim 17, wherein the agent of the AI system validates the determined behavior patterns by applying natural language processing to categorize the determined behavior patterns, and compares the determined behavior patterns with the at least one network security policy to determine the anomalous network behavior at least in part.

19. The system of claim 13, wherein the agent of the AI system determines dynamic correlations between a source signature of a request by an end user at one or more network layers of the network, and determine a link between the determined anomalous behavior to a unique identifier (ID) and an originating internet protocol (IP) address.

20. The system of claim 13, wherein the server integrates the QoS policies with at least one selected from a group consisting of: external security system policies, cloud-native security policies, and network-native security policies, and executes the integrated QoS policies on the determined anomalous behavior.

21. The system of claim 13, wherein the dynamically generating or updating the at least one network security policy is based on grouping end users by using the plurality of network activities.

22. The system of claim 21, wherein the grouping end users is based on one or more templates.

23. The system of claim 13, further comprises a database communicatively coupled to the server configured to store the end user data.

24. The system of claim 23, wherein the agent of the AI system analyzes contents of the database, and generates QoS parameters and one or more policies to be applied to the network, wherein the network is at least one selected from a group consisting of: a computer network, and a cloud-based network.
